(19) United States
(12) Patent Application Publication
(10) Pub. No.: US 2008/0303447 A1
(43) Pub. Date: Dec. 11, 2008

(54) INVERTER APPARATUS

(75) Inventor: Kenichi FUKUMOTO, Kyoto (JP)

Correspondence Address: CANTOR COLBURN, LLP, 20 Church Street, 22nd Floor, Hartford, CT, 06103, US

(73) Assignee: ROHM CO., LTD., Kyoto (JP)

(21) Appl. No.: 12/052,143

(22) Filed: Mar. 20, 2008

(30) Foreign Application Priority Data
Mar. 20, 2007 (JP) JP2007-071893

(51) Int. Cl. H05B 41/14; H02M 5/40

(52) U.S. Cl. 315/206; 363/34

(57) ABSTRACT

An inverter converts input voltage to AC driving voltage to supply it to a load. Secondary coil of an output transformer are connected to the load. Secondary coil of a main transformer are connected to the primary coil of the output transformer. A driving circuit applies switching voltage alternately repeating the input voltage and ground voltage to the primary coil of the main transformer.

### BACKGROUND OF THE INVENTION

1. Field of the Invention

The present invention relates to an inverter apparatus converting DC (direct current) voltage into AC (alternating current) voltage.

2. Description of the Related Art

In recent years, a LCD (Liquid Crystal Display) TV which can be thin and large has been widely spread, instead of a CRT (Cathode Ray Tube) TV. The LCD TV includes a plurality of cold cathode fluorescent lamps (hereinafter, referred to as “CCFL”) or external electrode fluorescent lamps (hereinafter, referred to as “EEFL”) disposed on a rear surface of a liquid crystal panel which displays image to light-emit them as backlights.

The LCD TV, etc. has a power supply apparatus converting commercial AC voltage into DC voltage of several hundreds volts by means of AC/DC conversion. Such a power supply apparatus is divided into a primary side-region and a secondary side-region that are electrically insulated from each other.

Together with such a power supply apparatus, an inverter (DC/AC converter) which boosts DC voltage of several hundreds volts and converts it into AC voltage, to supply it to a fluorescent lamp, will be described. FIG. 1 is a block view showing a constitution of a power supply system 500 including a primary side-region 510 and a secondary side-region 520. The power supply system 500 includes an AC/DC converter 410 which converts commercial AC voltage Vac into DC voltage Vdc, and an inverter apparatus 420 which converts the DC voltage Vdc output from the AC/DC converter 410 to AC driving voltage Vdrv to supply it to a fluorescent lamp 430 that is a load.

For example, the AC/DC converter 410 is configured of a full-wave rectifying circuit 412 and a power factor control circuit 414. Output voltage from the AC/DC converter 410 is output to the inverter apparatus 420 as the DC voltage Vdc .

The inverter apparatus 420 includes a driving circuit 422 and a transformer 424, The driving circuit 422 monitors an electrical state of electric current flowing or voltage applied in or to the fluorescent lamp 430, that is the subject to be driven, to feedback and control switching voltage applied to the primary coil (windings) of the transformer 424.

In the circuit of FIG. 1, a photo coupler 440, etc. is used in order to feedback the electrical state of the fluorescent lamp 430 disposed in the secondary side-region 520 to the driving circuit 422 disposed in the primary side-region 510. For example, the current flowing in the fluorescent lamp 430 is converted into an electrical signal Sfb1 by means of a resistor element 432. The electrical signal Sfb1 is input to the photo coupler 440 to be converted into an optical signal one time by means of a light emitting diode, etc. The converted optical signal is received by means of a photodiode or a phototransistor, etc. disposed in the primary side-region 510, is converted again into an electrical signal Sfb2, and is fedback to the driving circuit 422. Japanese Patent Application Laid-Open No. 2003-153529 discloses the relevant techniques. Also, there is a case where the signal is fedback from the secondary side-region 520 to the primary side-region 510 using electromagnetic coupling in the transformer, instead of the photo coupler.

The power supply system 500 of FIG. 1 is divided into the primary side-region 510 and the secondary side-region 520. For such a power supply system 500, the AC/DC converter 410 is disposed in the primary side-region 510 and the fluorescent lamp 430 is disposed in the secondary side-region 520. Also, a portion of the inverter apparatus 420 is disposed by being divided into the primary side-region 510 and the secondary side-region 520 as shown in the drawings. Specifically, the driving circuit 422 and the primary coil of the transformer 424 are disposed in the primary side-region 510, and the secondary coil of the transformer 424 connected to the fluorescent lamp 430 are disposed in the secondary side-region 520.

Herein, in the case where the fluorescent lamp 430 and the inverter apparatus 420 are disposed to be separate from each other, distance of a signal line transmitting the high driving voltage Vdrv becomes long. If high voltage is transmitted over a long distance, a problem of leakage, etc. arises. Also, a problem arises in that a high voltage cable is expensive.

### SUMMARY OF THE INVENTION

The invention is designed to solve these problems, and a general object of the invention is to provide an inverter apparatus shortening a signal line of high voltage.

An embodiment of the present invention is to provide an inverter apparatus which converts input voltage to AC driving voltage to supply it to a load. The inverter apparatus includes: an output transformer of which secondary coil are connected to the load; a main transformer of which secondary coil are connected to the primary coil of the output transformer; and a driving circuit which applies switching voltage alternately repeating the input voltage and a predetermined fixed voltage to the primary coil of the main transformer.

According to the embodiment, the output transformer is formed between the main transformer and the load to properly set a coil ratio between the main transformer and the output transformer so that voltage level between the main transformer and the output transformer can be lowered.

The driving circuit may include: a switching circuit which includes a plurality of transistors connected to the primary coil of the main transformer and supplies switching voltage alternately showing the input voltage and the fixed voltage on the primary coil of the main transformer corresponding to a turn-on and a turn-off of the plurality of transistors; a plurality of pulse transformers which is provided for every plurality of transistors and have each secondary coil connected to control terminals of corresponding transistors; and a control circuit which supplies pulse voltage to the primary coils of the plurality of pulse transformers.

In a power supply handling high voltage, it is requested to form a circuit which is divided into a primary side-region and a secondary side-region that should be electrically insulated from each other. If the primary coil of the main transformer are disposed in the primary side-region, the load connected to the secondary coil of the main transformer is disposed in the secondary side-region. Also, the pulse transformer is formed so that the control circuit is disposed in the secondary side-region. Therefore, both the load and the control circuit are disposed in the secondary side-region so that they can feedback with each other, without insulating a load state to the control circuit.

The output transformers are plural and may have each primary coil connected in series to the secondary coil of the main transformer to form a loop. In this case, primary current flowing in the primary coils of the plurality of output transformers is shared so that a plurality of loads can be uniformly driven.

The main transformer and the driving circuit may be disposed on a first substrate, and the output transformer may be disposed on a second substrate. The secondary coil of the main transformer on the first substrate and the primary coils of the output transformer on the second substrate may be connected through a cable.

The plurality of transistors may be MOSFET (metal oxide semiconductor field effect transistor) and each secondary coil of the plurality of pulse transformers may be provided on a path from gates to sources of the corresponding plurality of transistors.

The control circuit may supply the pulse voltage to the primary coils of the plurality of pulse transformers so that current flowing in the load approaches a desired current value.

Another embodiment of the present invention is to provide a power supply apparatus which includes a primary side-region and a secondary side-region that should be electrically insulated from each other. The power supply apparatus includes: an AC/DC converter which is disposed in the primary side-region and converts input commercial AC voltage into DC voltage; and an inverter apparatus which receives the DC voltage output from the AC/DC converter, as input voltage, and converts it into AC voltage to supply it to a load disposed in the secondary side-region.

Another embodiment of the present invention is also to provide a power supply apparatus. The power supply apparatus, which includes a primary side-region and a secondary side-region that should be electrically insulated from each other, includes: an AC/DC converter which is disposed in the primary side-region and converts input commercial AC voltage into DC voltage; and an inverter apparatus which receives DC voltage output from the AC/DC converter, as input voltage, and converts it into AC voltage to supply it to a load disposed in the secondary side-region. The switching circuit, secondary coils of the plurality of pulse transformers, and primary coil of the main transformer of the inverter apparatus are disposed in the primary side-region, and the control circuit, primary coils of the plurality of pulse transformers, secondary coil of the main transformer, and the output transformer of the inverter apparatus are disposed in the secondary side-region.

Another embodiment of the present invention is also to provide a light-emitting apparatus. The light-emitting apparatus includes: a fluorescent lamp; and an above mentioned power supply apparatus which supplies AC driving voltage having the fluorescent lamp that is a load.

The fluorescent lamp may be a cold cathode fluorescent lamp or an external electrode fluorescent lamp.

Another embodiment of the present invention is to provide a picture display apparatus. The apparatus includes: a liquid crystal panel; and a light-emitting apparatus disposed on a rear surface of the liquid crystal panel as a backlight.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block view showing a constitution of a power supply system which includes a primary side-region and a secondary side-region;

FIG. 2 is a circuit view showing a constitution of an inverter related to an embodiment of the present invention;

FIG. 3 is a block view of an entire constitution of a light-emitting apparatus which includes the inverter of FIG. 2; and

FIG. 4 is a block view showing a constitution of a LCD TV mounted with the light-emitting apparatus of FIG. 3.

### DESCRIPTION OF THE PREFERRED EMBODIMENTS

The invention will now be described based on preferred embodiments which do not intend to limit the scope of the present invention but exemplify the invention. All of the features and the combinations thereof described in the embodiment are not necessarily essential to the invention.

In the specification, a state where “an element A is connected to an element B” includes a case where the element A is physically and directly connected to the element B, and a case where the element A is indirectly connected to the element B through another element not affecting an electrical connection state.

In the same manner, a state where “an element C is provided between an element A and an element B” includes a case where the element A is directly connected to the element C, or the element B is directly connected to the element C, and a case where they are indirectly connected through an another element not affecting an electrical connection state.

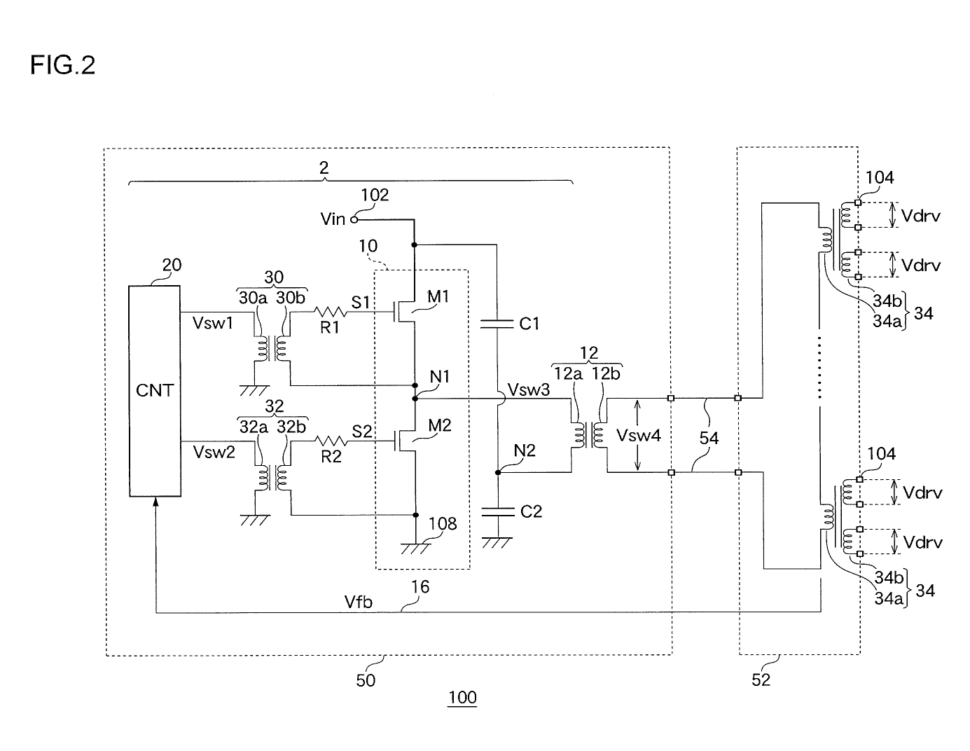

FIG. 2 is a circuit view showing a constitution of an inverter 100 related to an embodiment of the present invention. The inverter 100 is a DC/AC converter which receives input voltage Vin applied to an input terminal 102 and converts it into AC driving voltage Vdrv to supply it to a fluorescent lamp (not shown) connected to an output terminal 104.

The inverter 100 includes a driving circuit 2, a main transformer 12, and a plurality of output transformers 34. The output transformers 34 include primary coil 34a and secondary coil 34b. The secondary coil 34b of the output transformer 34 are connected with the fluorescent lamp (not shown) that is a load. In the embodiment, the plurality of output transformers 34 are provided in order to drive a plurality of fluorescent lamps, but the number thereof is optional.

The main transformer 12 includes primary coil 12a and secondary coil 12b. The secondary coil 12b of the main transformer 12 are connected to the primary coil 34a of the plurality of output transformers 34. Specifically, each primary coil 34a is connected in series to the secondary coil 12b of the main transformer 12 to form a loop. The plurality of output transformers 34 are disposed on the same substrate (hereinafter, referred to as “second substrate 52”),

The driving circuit 2 applies switching voltage Vsw3 to the primary coil 12a of the main transformer 12. The switching voltage Vsw3 alternately repeats the input voltage Vin and a predetermined fixed voltage (ground voltage) . The constitution of the driving circuit 2 is not specifically limited, but the present invention can use various driving circuits. The driving circuit 2 and the main transformer 12 are disposed on a first substrate 50, not on the second substrate 52.

The first substrate 50 is connected to the second substrate 52 through a cable 54.

The above is the entire constitution of the inverter 100. Next, an operation of the inverter 100 will be described.

The input terminal 102 is applied with, for example, DC voltage of about 100V to 400V , as the input voltage Vin. The primary coil 12a of the main transformer 12 are applied with the switching voltage Vsw3 alternately repeating a high level (Vin) and a low level (0V) by the driving circuit 2. As a result, switching voltage Vsw4 corresponding to a coil ratio of the main transformer 12 is applied to the secondary coil 12b of the main transformer 12.

The switching voltage Vsw4 is applied to the primary coil 34a of the output transformer 34 through the cable 54. As a result, the driving voltage Vdrv corresponding to the coil ratio is applied to the secondary coil 34b of each output transformer 34, The driving voltage Vdrv is supplied to the fluorescent lamp (not shown) . The operation of the inverter 100 is described above.

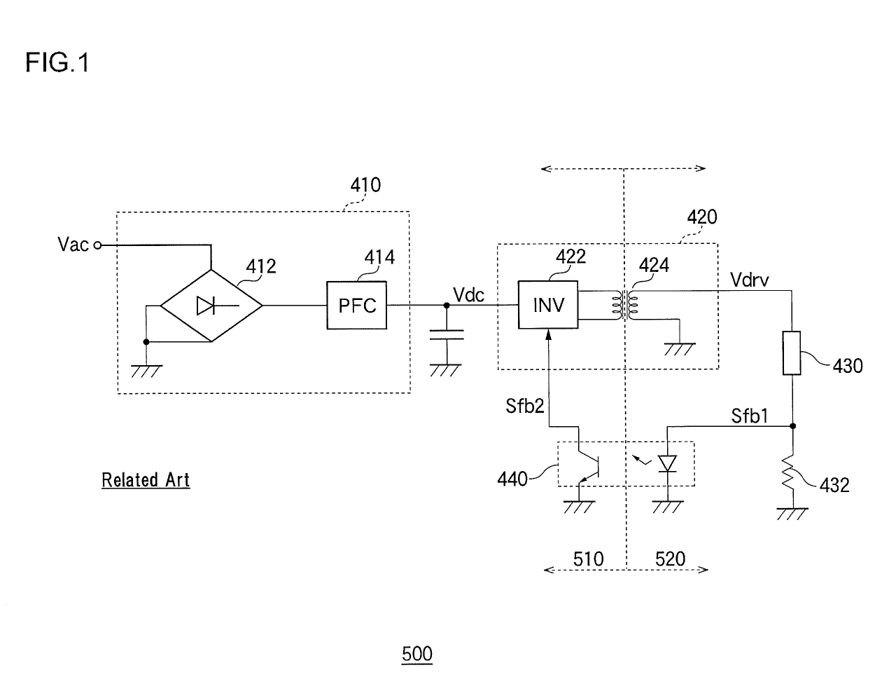

Advantages of the inverter 100 described above will be clarified by means of the comparison with the power supply system 500 of FIG. 1. Hereinafter, it will be described assuming that the input voltage Vin=400V and the driving voltage Vdrv=1.5 kv.

The driving circuit 2 of FIG. 2 corresponds to the driving circuit 422 in the power supply system 500 of FIG. 1. Also, the main transformer 12 and the output transformer 34 of FIG. 2 correspond to the transformer 424 of FIG. 1.

When the power supply system 500 of FIG. 1 is installed in TV set, there is a case where the substrate on which the driving circuit 422 and the transformer 424 are actually mounted is separated from the fluorescent lamp 430. In this case, the transformer 424 is connected to the fluorescent lamp 430 through the cable so that very high driving voltage Vdrv (=1.5 kV) is transmitted through the cable. When using the power supply system 500 of FIG. 1, use of a high withstand voltage cable is needed. Therefore, leakage from the cable becomes a more serious problem.

On the other hand, in the inverter 100 of FIG. 2 relating to the embodiment, the output transformer 34 is mounted on the second substrate 52, not on the first substrate 50, so that it may be disposed just beside of the fluorescent lamp.

Now, if a coil ratio TR1 of the main transformer 12 is set to be small, for example, TR1≈1, the switching voltage Vsw4 has amplitude (=400 V) to the extent that it is the same as the input voltage Vin. Furthermore, a coil ratio TR2 of the output transformer 34 is set to obtain a desired driving voltage Vdrv using the switching voltage Vsw4 (=400 V).

As a result, the voltage level transmitted through the cable 54 connecting the first substrate 50 to the second substrate 52 can be lowered to about 400V . Compared with the driving voltage of 1.5 kV transmitted through the cable in FIG. 1, it is reduced to about one-fourth to about one-third thereof. As a result, withstand voltage of the cable can be lowered than that of the power supply system 500 of FIG. 1, making it possible to further suppress leakage from the cable 54.

Also, in the second substrate 52, common current flows in each primary coil 34a of the plurality of output transformers 34 so that the driving voltage Vdrv applied to the secondary coil 34b of the output transformer 34 can be uniform, making it possible to uniformly drive the plurality of loads.

In the embodiment, in order to obtain the effects described as above, the constitution of the driving circuit 2 is not specifically limited, but the present invention has new advantages by means of the following constitution. Hereinafter, the constitution of the driving circuit 2 will be described in detail.

The driving circuit 2 includes a switching circuit 10, a feedback line 16, a control circuit 20, a first pulse transformer 30, a second pulse transformer 32, a first capacitor C1, a second capacitor C2, a first level shift resistor R1, and a second level shift resistor R2.

The switching circuit 10 includes a high-side transistor M1 and a low-side transistor M2 connected in series between the input terminal 102 and a ground terminal 108 applied with ground voltage that is fixed voltage. Tn the embodiment, the main transformer 12 is half bridge connected to the high-side transistor M1 and the low-side transistor M2.

Both the high-side transistor M1 and the low-side transistor M2 are configured of an N-channel MOSFET. In other words, a source of the high-side transistor M1 is connected to a drain of the low-side transistor M2, and a drain of the high-side transistor M1 is connected to the input terminal 102 and a source of the low-side transistor M2 is connected to the ground terminal 108. Furthermore, the high-side transistor M1 and the low-side transistor M2 may be constituted using a P-channel MOSFET or a bipolar transistor. Also, the switching circuit 10 may be constituted using an H-bridge circuit.

The gate of the high-side transistor M1 and the low-side transistor M2 is input with a first control signal S1 and a second control signal S2, respectively. If the first control signal S1 is in a high level, the high-side transistor M1 turns-on, and if the second control signal S2 becomes a high level, the low-side transistor M2 turns-on. If the high-side transistor M1 turns-on, the switching voltage Vsw3 appearing at a connection node N1 becomes approximately the same as the input voltage Vin, and if the low-side transistor M2 turns-on, the switching voltage Vsw3 becomes approximately the same as the ground voltage 0V.

The connection node N1 between the high-side transistor M1 and the low-side transistor M2 is connected to one end of the primary coil 12a of the main transformer 12. The other end N2 of the primary coil 12a is connected to the input terminal 102 through the first capacitor C1 and is connected to the ground terminal through the second capacitor C2. The switching circuit 10 applies the switching voltage Vsw3 alternately repeating the input voltage Vin and the ground voltage to the primary coil 12a of the main transformer 12.

The feedback line 16 is a wire which feed backs a feedback signal Vfb representing an electrical state of a load, to the control circuit 20. For example, a load state may be the current flowing in the fluorescent lamp and the driving voltage applied to the fluorescent lamp, or a combination thereof.

The first pulse transformer 30 and the second pulse transformer 32 are provided for every plurality of transistors M1 and M2 of the switching circuit 10. One end of the secondary coil 30b of the first pulse transformer 30 is connected to the source of high-side transistor M1, and the other end thereof is connected to the gate of the high-side transistor M1 through the first level shift resistor R1. In the same manner, one end of the secondary coil 32b of the second pulse transformer 32 is connected to the source of the low-side transistor M2, and the other end thereof is connected to the gate of the low-side transistor M2 through the second level shift resistor R2. In other words, the respective secondary coil 30b and 32b of the first pulse transformer 30 and the second pulse transformer 32 are provided on a path from the gates to the sources of the high-side transistor M1 and the low-side transistor M2.

The control circuit 20 receives the feedback signal Vfb fedback through the feedback line 16. The control circuit 20 supplies first switching voltage Vsw1 and second switching voltage Vsw2 to the primary coil 30a of the first pulse transformer 30 and the secondary coil 32a of the second pulse transformer 32, based on the feedback signal Vfb.

The driving method of the main transformer 12 based on the feedback may be appreciated using a publicly known technique. Hereinafter, one example thereof will be described.

As the control circuit 20, a control circuit for an inverter including a general pulse width modulator may be used. For example, the control circuit 20 includes an error amplifier, an oscillator, and a comparator. The error amplifier amplifies the error between the feedback signal Vfb fedback through the feedback line 16 and the reference voltage Vref set corresponding to brightness of the fluorescent lamp 210 to output an error signal Verr. The oscillator outputs a periodic signal Vosc in a triangular wave or a saw-tooth wave shape of a predetermined frequency. The comparator compares the periodic signal Vosc with the error signal Verr to output a pulse width modulation signal (hereinafter, referred to as “PWM signal Vpwm”) of which high level and low level are changed according to the large/small relation thereof. The control circuit 20 outputs the PWM signal Vpwm as the first switching voltage Vsw1 and the second switching voltage Vsw2 through a driver circuit. The first switching voltage Vsw1 and the second switching voltage Vsw2 are signals of which logic values are inverted to each other.

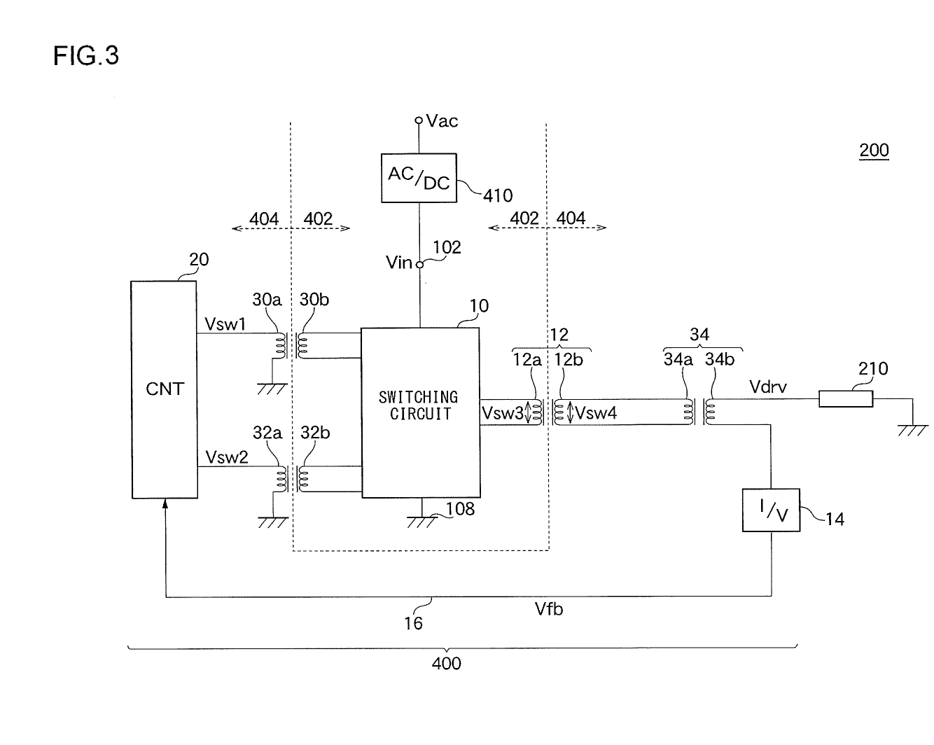

FIG. 3 is a block view of an entire constitution of a light-emitting apparatus 200 which includes the inverter 100 of FIG. 2. The light-emitting apparatus 200 includes a power supply system 400 and a fluorescent lamp 210. Although one fluorescent lamp 210 and one output transformer 34 are shown in FIG. 3, a plurality of output transformers 34 may be provided, as shown in FIG. 2.

The power supply system 400 is divided into a primary side-region 402 and a secondary side-region 404, wherein the primary side-region 402 and the secondary side-region 404 are electrically insulated from each other. An AC/DC converter 410 which converts commercial AC voltage Vac into DC voltage is disposed in the primary side-region 402. Meanwhile, a fluorescent lamp 210 that is a load is disposed in the secondary side-region 404. A current-voltage converting unit 14 generates a feedback signal Vfb by converting current flowing in the fluorescent lamp 210 into voltage to feedback it to a control circuit 20 through a feedback line 16.

In FIG. 3, the power supply system 400 includes the AC/DC converter 410 and the inverter 100 of FIG. 2. In other words, a member excepting the AC/DC converter from the power supply system 400 of FIG. 3 corresponds to the inverter 100 of FIG. 2.

In such a power supply system 400, each block of the inverter 100 related to the embodiment will be disposed as follows. That is, the primary side-region 402 is disposed with the primary coil 12a of the main transformer 12, the switching circuit 10, the secondary coil 30b of the first pulse transformer 30, and the secondary coil 32b of the second pulse transformer 32.

Meanwhile, the secondary side-region 404 is disposed with the secondary coil 12b of the main transformer 12, the output transformer 34, the current-voltage converting unit 14, the feedback line 16, the control circuit 20, the primary coil 30a of the first pulse transformer 30, and the primary coil 32a of the second pulse transformer 32.

The operation of the power supply system 400 constituted as above will be described, The first switching voltage Vsw1, which is an inverse phase to the second switching voltage Vsw2, repeats a high level and a low level based on the feedback signal Vfb from the current-voltage converting unit 14, The first switching voltage Vsw1 applied to the primary coil 30a of the first pulse transformer 30 is amplified corresponding to a coil ratio of the first pulse transformer 30, and is further level-shifted by means of the first level shift resistor R1 to supply enough voltage, that the high-side transistor M1 can be turned-on, to the gate-source of the high-side transistor M1. In the same manner, the second switching voltage Vsw2 applied to the primary coil 32a of the second pulse transformer 32 is amplified corresponding to the coil ratio of the second pulse transformer 32 and is level-shifted by means of the second level shift resistor R2 to supply enough voltage, that the low-side transistor M2 can be turned-on, to the gate-source of the low-side transistor M2. As a result, the high-side transistor M1 and the low-side transistor M2 alternately repeat a turn-on and a turn-off according to a duty ratio of the PWM signal Vpwm generated by the control circuit 20.

If the high-side transistor M1 and the low-side transistor M2 alternately repeat a turn-on and a turn-off, the primary coil 12a of the main transformer 12 are alternately applied with the input voltage Vin and the ground voltage (0V) as the switching voltage Vsw3 so that the main transformer 12 is supplied with energy, As a result, a switching voltage Vsw4 corresponding to the coil ratio of the main transformer 12 is applied to the secondary coil 12b of the main transformer 12. The driving voltage Vdrv corresponding to the switching voltage Vsw4 is applied to the secondary coil 34b of the output transformer 34 and is supplied to the fluorescent lamp 210.

The duty ratio of the PWM signal Vpwm is controlled in order that the feedback signal Vfb corresponds to the reference voltage Vref by means of the control circuit 20. As a result, tube current of the fluorescent lamp 210 is maintained at a predetermined value to obtain a desired brightness so that the fluorescent lamp 210 is safely light-emitted.

With the inverter 100 and the power supply system 400 related to the embodiment, the following effects can be achieved. The advantages of the power supply system 400 will be clarified, compared with the power supply system 500 of FIG. 1.

In the power supply system of FIG. 1 or FIG. 3, the primary side-region and the secondary side-region must be electrically insulated.

In the power supply system 500 of FIG. 1, the photo coupler 440, etc. is used in order to feedback the electrical state of the fluorescent lamp 430 disposed in the secondary side-region 520 to the driving circuit 422 disposed in the primary side-region 510. For example, the current flowing in the fluorescent lamp 430 is converted into an electrical signal Sfb1 by means of the resistor element 432. The electrical signal Sfb1 is input to the photo coupler 440 to be converted into an optical signal one time by means of a light emitting diode, etc. The converted optical signal is received by means of the photodiode or the phototransistor disposed in the primary side-region 510, is converted again into the electrical signal Sfb2, and is fedback to the driving circuit 422.

As explained above, when the signal is transmitted from the secondary side-region 520 to the primary side-region 510 using the photo coupler, the electrical signal is converted into the optical signal so that a problem arises in that precision of the feedback is deteriorated. Also, for the photo coupler, if coupling efficiency between light-emitting elements and receiving elements is changed, a problem arises in that light emitting brightness of a fluorescent tube is changed.

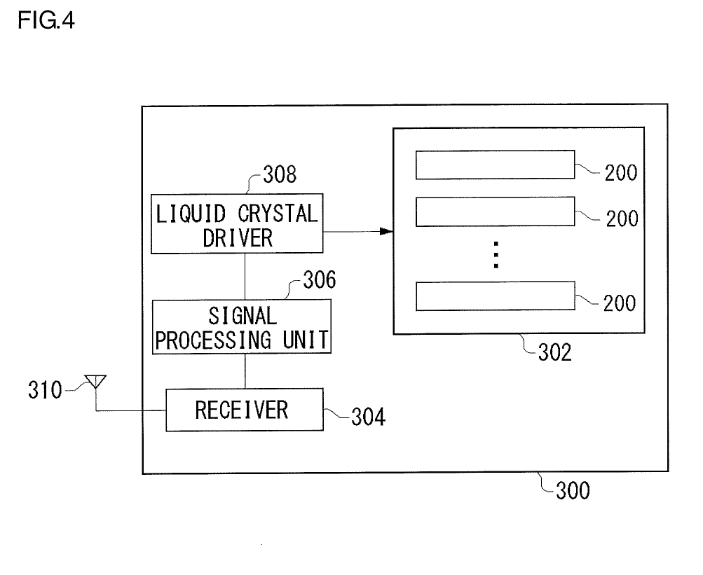

On the other hand, in the embodiment, the first pulse transformer 30 and the second pulse transformer 32 are formed to maintain an insulating state between the primary side-region 402 and the secondary side-region 404 so that the control circuit 20 of the inverter 100 is disposed in the secondary side-region 404. In other words, both the control circuit 20 and the fluorescent lamp 210 are disposed in the secondary side-region 404, making it possible to directly connect the feedback line 16 thereto. As a result, components such as the photo coupler, etc. can be reduced. Also, the inverter 100 related to the embodiment can safely drive the load, compared with the case where the feedback control is performed by means of the photo coupler. Although only one fluorescent lamp 210 is shown in FIG. 4, a plurality of fluorescent lamps 210 and a plurality of control circuits 20 are mounted in actual set so that the feature capable of replacing the photo coupler with the feedback line 16 has great merits in view of the actual mounting area and costs.

In the embodiment, although each coil ratio of the first pulse transformer 30 and the second pulse transformer 32 is deviated so that a coupling coefficient between the primary coil and the secondary coil is changed, it rarely affects a driving state of the fluorescent lamp 210. The reason is that since information transferred from the secondary side-region 404 to the primary side-region 402 through the first pulse transformer 30 and the second pulse transformer 32 is in a turn-on or a turn-off state of the high-side transistor M1 and the low-side transistor M2, it rarely affects energy transferred to the main transformer 12, although the voltage levels of the first control signal S1 and the second control signal S2 are changed accompanying with the change in the coupling coefficient. Also, although a turn-on or a turn-off of the high-side transistor M1 and the low-side transistor M2 is changed by means of the change in the coupling coefficient, in order to compensate for the turn-on or the turn-off, the duty ratio of the first switching voltage Vsw1 and the second switching voltage Vsw2 are changed and fedback in order to maintain the tube current Ilamp at a desired value, so that the driving state of the fluorescent lamp 210 is also safely maintained.

In the embodiment, withstand voltage of a driver circuit which supplies the first switching voltage Vsw1 and the second switching voltage Vsw2 to the primary coil 30a of the first pulse transformer 30 and the primary coil 32a of the second pulse transformer 32, can be lowered. In other words, in the system of FIG. 1 or FIG. 4, when the input voltage is high, such as 100V or more, a very high voltage needs to be applied as the gate voltage, in order to turn-on or turn-off the transistor of the switching circuit 10. In the system of FIG. 1, since voltage needs to be directly supplied to the gate of the transistor of the switching circuit 10, not through the pulse transformer, the driving circuit needs to have a high withstand voltage. Meanwhile, in the inverter 100 related to the embodiment, in order to drive the transistor of the switching circuit 10 through the first pulse transformer 30 and the second pulse transformer 32, it is sufficient for the driving circuit to supply voltage of several volts to several tens of volts to the primary coil 30a of the first pulse transformer 30 and the primary coil 32a of the second pulse transformer 32 so that a high withstand voltage to that extent is not needed, From such a ground, the embodiment has an advantage that the driver circuit can be built-in one integrated circuit.

FIG. 4 is a block view showing a constitution of a LCD TV 300 mounted with the light-emitting apparatus 200 of FIG. 3. The LCD TV 300 of FIG. 3 is connected by an antenna 310. The antenna 310 receives a broadcasting wave to output a receiving signal to a receiver 304. The receiver 304 detects and amplifies the receiving signal to output it to a signal processing unit 306. The signal processing unit 306 outputs picture data which can be obtained by demodulating modulated data to a liquid crystal driver 308. The liquid crystal driver 308 outputs the picture data to a liquid crystal panel 302 per scan line to display an image and a picture. The rear surface of the liquid crystal panel 302 is disposed with a plurality of light-emitting apparatuses 200 as a backlight. The light-emitting apparatus 200 related to the embodiment can be very suitably used as a backlight of such a liquid crystal panel 302. Also, the light-emitting apparatus 200 can be very suitably used for a liquid crystal display, etc., other than the LCD TV 300.

The embodiments of the present invention are just illustrative. It will be understood by those skilled in the art that various modifications in the combination of each constituent and each process can be made without departing from the scope and spirit of the invention.

In the embodiments of the present invention, the case where a transistor of a switching circuit 10 is constituted using an N-channel MOSFET is explained, but it can be constituted using a P-channel MOSFET. Also, the present invention is not limited to a half-bridge circuit, but a full-bridge circuit or another circuit constitution can be used. In the case of the full-bridge circuit, the switching circuit 10 may include a first high-side transistor and a first low-side transistor connected in series on a first path between an input terminal 102, and a ground terminal, and a second high-side transistor and a second low-side transistor connected in series on a second path between the input terminal 102 and the ground terminal.

In the circuit view of FIG. 3, although potential of one end of a fluorescent lamp 210 is constant, the present invention is not limited thereto, but it can be driven by applying voltage that becomes an inverse phase to driving voltage Vdrv applied to the other end, instead of fixing the potential. Alternatively, when a U-type fluorescent lamp is used, the driving voltage Vdrv may be applied to the both ends thereof.

In the embodiments of the present invention, the case where the light-emitting apparatus 200 drives one fluorescent lamp 210 is described for simplifying the description, a plurality of fluorescent lamps 210 may actually be driven. In this case, a publicly known technique for driving the plurality of fluorescent lamps 210 may be used, and in particular, the present invention can be applied without being limited to a specific topology.

Also, the load driven by an inverter 100 related to the embodiment of the present invention is not limited to a fluorescent tube, but it can be applied to driving of various devices that require other AC high voltage.

In the embodiment of the present invention, a setting of logic values of a high level and a low level of a logic circuit is just one example, but it can be freely modified by being properly inverted by means of an inverter, etc.

While the preferred embodiments of the present invention have been described using specific terms, such description is for illustrative purposes only, and it is to be understood that changes and variations may be made without departing from the spirit or scope of the appended claims.

What is claimed is:

1. An inverter apparatus which converts input voltage to AC driving voltage to supply it to a load, the inverter apparatus comprising:
an output transformer of which secondary coil are connected to the load;
a main transformer of which secondary coil are connected to a primary coil of the output transformer; and
a driving circuit which applies switching voltage alternately repeating the input voltage and a predetermined fixed voltage to a primary coil of the main transformer.

2. The inverter apparatus according to claim 1, wherein
the driving circuit includes:
a switching circuit which includes a plurality of transistors connected to the primary coil of the main transformer and supplies switching voltage alternately showing the input voltage and the fixed voltage on the primary coil of the main transformer corresponding to a turn-on and a turn-off of the plurality of transistors;
a plurality of pulse transformers which are provided for every plurality of transistors and have each secondary coil connected to control terminals of corresponding transistors; and
a control circuit which supplies pulse voltage to primary coils of the plurality of pulse transformers.

3. The inverter apparatus according to claim 1, wherein
the output transformers are plural and have each primary coil connected in series to the secondary coil of the main transformer to form a loop.

4. The inverter apparatus according to claim 1, wherein
the main transformer and the driving circuit are disposed on a first substrate, the output transformer is disposed on a second substrate, and the secondary coil of the main transformer on the first substrate and the primary coil, of the output transformer on the second substrate being connected through a cable.

5. The inverter apparatus according to claim 2, wherein
the plurality of transistors are MOSFET (metal oxide semiconductor field effect transistor) and each secondary coil of the plurality of pulse transformers is provided on a path from gates to sources of the corresponding plurality of transistors.

6. The inverter apparatus according to claim 2, wherein
the control circuit supplies the pulse voltage to primary coils of the plurality of pulse transformers so that current flowing in the load approaches a desired current value.

7. A power supply apparatus which includes a primary side-region and a secondary side-region that should be electrically insulated from each other, the power supply apparatus comprising:
an AC/DC converter which is disposed in the primary side-region and converts input commercial AC voltage into DC voltage; and
an inverter apparatus according to claim 1 which receives the DC voltage output from the AC/DC converter, as input voltage, and converts it into AC voltage to supply it to a load disposed in the secondary side-region.

8. A power supply apparatus which includes a primary side-region and a secondary side-region that should be electrically insulated from each other, the power supply apparatus comprising:
an AC/DC converter which is disposed in the primary side-region and converts input commercial AC voltage into DC voltage; and
an inverter apparatus according to claim 2 which receives DC voltage output from the AC/DC converter, as input voltage, and converts it into AC voltage to supply it to load disposed in the secondary side-region, wherein
the switching circuit, secondary coils of the plurality of pulse transformers, and primary coil of the main transformer of the inverter apparatus are disposed in the primary side-region, and the control circuit, primary coils of the plurality of pulse transformers, secondary coil of the main transformer, and the output transformer of the inverter apparatus are disposed in the secondary side-region.

9. A light-emitting apparatus, comprising:
a fluorescent lamp; and
a power supply apparatus according to claim 7 which supplies AC driving voltage having the fluorescent lamp that is a load.

10. The light-emitting apparatus according to claim 9,
wherein
the fluorescent lamp is a cold cathode fluorescent lamp.

11. The light-emitting apparatus according to claim 9,
wherein
the fluorescent lamp is an external electrode fluorescent lamp,

12. A picture display apparatus, comprising:
a liquid crystal panel; and
a light-emitting apparatus according to claim 9 disposed on a rear surface of the liquid crystal panel as a backlight.
